(19) United States
(12) Patent Application Publication
(10) Pub. No.: US 2022/0317594 A1
(43) Pub. Date: Oct. 6, 2022

(54) IMAGE FORMING APPARATUS AND TONER STORAGE CONTAINER ATTACHMENT/DETACHMENT METHOD

(71) Applicant: Konica Minolta, Inc., Tokyo (JP)

(72) Inventors: MAKOTO FUJIMOTO, Toyokawa-shi (JP); TAKERU KINOSHITA, Toyokawa-shi (JP); JUNJI MURAKAWA, Toyokawa-shi (JP)

(21) Appl. No.: 17/705,081

(22) Filed: Mar. 25, 2022

(30) Foreign Application Priority Data
Apr. 2, 2021 (JP) 2021-063423

(51) Int. Cl. G03G 15/08

(52) U.S. Cl. CPC G03G 15/0886

(57) ABSTRACT

There is provided an image forming apparatus capable of detachably attaching a toner storage container including: a bottle that stores toner; a discharge port that opens the bottle; a first shutter member rotatably attached to the bottle between a closed position and an open position; and a second shutter member relatively movable with respect to the bottle in an attachment/detachment direction, and the image forming apparatus includes: a container storage that has a storage port and stores the toner storage container; a toner reservoir provided below the container storage and having a supply port formed below the discharge port of the toner storage container stored in the container storage; a regulator that moves the second shutter member; a cover member that opens or closes the storage port; and a switcher that rotates the first shutter member of the toner storage container stored in the container storage.

The entire disclosure of Japanese patent Application No. 2021-063423, filed on Apr. 2, 2021, is incorporated herein by reference in its entirety.

### BACKGROUND

### Technological Field

The present invention relates to an image forming apparatus that forms an image on a recording medium using toner supplied from a detachable toner storage container, and a toner storage container attachment/detachment method for attaching and detaching the toner storage container to and from the image forming apparatus.

### Description of the Related Art

An image forming apparatus represented by a multi function peripheral (MFP) includes a developing device that develops an electrostatic latent image formed on a photosensitive drum with toner, and a toner storage container that stores the toner to be supplied to the developing device. The toner storage container is detachable from the image forming apparatus. The toner storage container has an opening connected to the developing device, and the opening is closed so that the toner stored in the toner storage container is not discharged from the opening when the toner storage container is attached or detached.

For example, Japanese Patent Application Laid-Open No. 2013-190586 discloses an image forming apparatus including an image forming unit, a toner container, a holding cover that rotatably holds the toner container in a normal position where the toner container is connected to a developing unit in a toner supply state and a detachment position above the normal position, a shutter that closes a toner supply port by an elastic force of a first elastic member, a shutter switching member that switches the shutter to an open position, and an interlocking mechanism that switches the shutter switching member to a position where the shutter switching member is retracted from a pressing position in conjunction with an opening operation of an upper cover of an apparatus main body, in which a shutter receiving the elastic force of the first elastic member closes the toner supply port by switching the shutter switching member to the retracted position by the opening operation of the upper cover.

However, in the image forming apparatus described in Japanese Patent Application Laid-Open No. 2013-190586, since the shutter closes the toner supply port, when toner is present around the toner supply port, the toner may adhere to the shutter. For this reason, when the toner container is detached from the image forming apparatus, the toner attached to the shutter may fall, and the inside or the outside of the image forming apparatus may be contaminated with the toner.

### SUMMARY

The present invention is made to solve the above-described problems, and an object of the present invention is to provide an image forming apparatus in which an amount of toner leaking from a toner storage container while the toner storage container is attached and detached is reduced.

Another object of the present invention is to provide a toner storage container attachment/detachment method of reducing an amount of toner leaking from a toner storage container while the toner storage container is attached to and detached from an image forming apparatus.

To achieve at least one of the abovementioned objects, according to an aspect of the present invention, there is provided an image forming apparatus capable of detachably attaching a toner storage container, the toner storage container including: a bottle that stores toner; a discharge port that opens the bottle to an outside; a first shutter member that is rotatably attached to the bottle between a closed position where the discharge port is closed and an open position where the discharge port is opened; and a second shutter member that is provided to be relatively movable with respect to the bottle in an attachment/detachment direction in which the toner storage container is attached/detached between a storage position where the toner storage container is separated from the first shutter member at the open position and a detachment position where the toner storage container is in contact with the first shutter member at the closed position, and the image forming apparatus reflecting one aspect of the present invention comprises: a container storage that has a storage port and stores the toner storage container; a toner reservoir that is provided below the container storage and has a supply port formed vertically below the discharge port of the toner storage container stored in the container storage; a regulator that moves the second shutter member from the detachment position to the storage position; a cover member that opens or closes the storage port; and a switcher that rotates the first shutter member of the toner storage container stored in the container storage in conjunction with an opening/closing operation of the cover member.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a first perspective view illustrating an appearance of a multi function peripheral (MFP) according to one embodiment of the present invention;

FIG. 2 is a cross-sectional view schematically illustrating an example of an internal configuration of the MFP;

FIG. 3 is a perspective view illustrating an appearance of a toner storage container and a sub-hopper;

FIG. 4 is a second perspective view illustrating an appearance of an MFP according to one embodiment of the present invention;

FIG. 5 is a view illustrating a state in which a toner storage container is replaced in the MFP;

FIG. 6 is a first perspective view illustrating a part of an example of the toner storage container;

FIG. 7 is a second perspective view illustrating a part of an example of the toner storage container;

FIG. 8 is a cross-sectional view of a part of the toner storage container in a state where a second shutter member is located at a storage position;

FIG. 9 is a cross-sectional view of a part of the toner storage container in a state where the second shutter member is located at a detachment position;

FIG. 10 is an enlarged perspective view illustrating a part of a container storage together with peripheral members;

FIG. 11 is a view of a part of an upper surface viewed from the inside of a toner reservoir of the sub-hopper in a state where a cover member is closed;

FIG. 12 is a view of a part of the upper surface viewed from the inside of the toner reservoir of the sub-hopper in a state where the cover member is opened;

FIG. 13 is a first cross-sectional view illustrating an example of a positional relationship between the sub-hopper and the toner storage container;

FIG. 14 is a second cross-sectional view illustrating an example of the positional relationship between the sub-hopper and the toner storage container;

FIG. 15 is a third cross-sectional view illustrating an example of the positional relationship between the sub-hopper and the toner storage container; and

FIG. 16 is a flowchart illustrating an example of a flow of a toner storage container attachment/detachment method.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same components are denoted by the same reference numerals. The names and functions are the same. Therefore, the detailed description thereof will not be repeated.

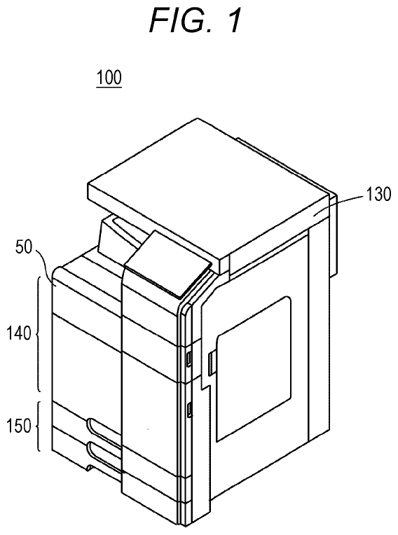

FIG. 1 is a first perspective view illustrating an appearance of a multi function peripheral (MFP) according to one embodiment of the present invention. Referring to FIG. 1, a multi function peripheral (MFP) 100 is an example of an image forming apparatus, and includes a cover member 50 constituting a part of a main body case on a front surface thereof. The cover member 50 is openable and closable, and FIG. 1 illustrates the MFP 100 in a closed state in which the cover member 50 is closed. Hereinafter, a horizontal direction from the back surface to the front surface of the MFP 100 is referred to as a front direction, and a horizontal direction from the front surface to the back surface is referred to as a back direction.

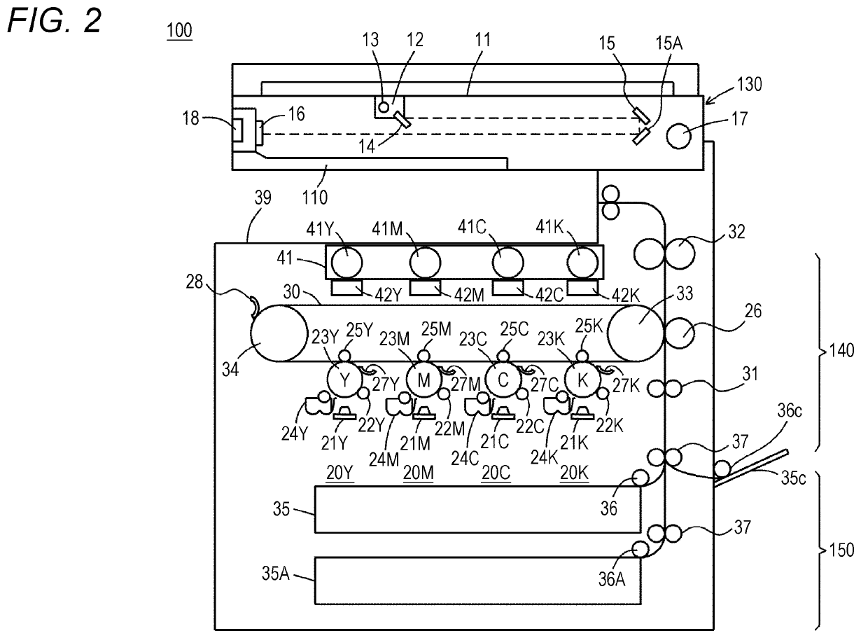

FIG. 2 is a cross-sectional view schematically illustrating an example of an internal configuration of the MFP. Referring to FIGS. 1 and 2, the MFP 100 includes a document reader 130 that reads a document, an image former 140 that forms an image on a sheet on the basis of image data, and a sheet feeder 150 that supplies a sheet to the image former 140.

The document reader 130 exposes an image of the document set on a document glass 11 with an exposure lamp 13 attached to a slider 12 moving below the document. Reflected light from the document is guided to a lens 16 by a mirror 14 and two reflection mirrors 15 and 15A, and forms an image on a charge coupled devices (CCD) sensor 18.

The reflected light formed on the CCD sensor 18 is converted into image data as an electric signal in the CCD sensor 18. The image data is converted into printing data of cyan (C), magenta (M), yellow (Y), and black (K) and output to the image former 140.

The image former 140 includes image forming units 20Y, 20M, 20C, and 20K of yellow, magenta, cyan, and black, respectively. Here, “Y”, “M”, “C”, and “K” represent yellow, magenta, cyan, and black, respectively. At least one of the image forming units 20Y, 20M, 20C, and 20K is driven to form an image. When all of the image forming units 20Y, 20M, 20C, and 20K are driven, a full-color image is formed. Print data of yellow, magenta, cyan, and black is input to the image forming units 20Y, 20M, 20C, and 20K, respectively. Since the image forming units 20Y, 20M, 20C, and 20K only have different colors of toner to be handled, the image forming unit 20Y for forming a yellow image will be described here.

The image forming unit 20Y includes an exposure device 21Y to which yellow printing data is input, a photosensitive drum 23Y as an image carrier, a charging roller 22Y for uniformly charging the surface of the photosensitive drum 23Y, a developing device 24Y, a primary transfer roller 25Y for transferring a toner image formed on the photosensitive drum 23Y onto an intermediate transfer belt 30 as an image carrier by the action of an electric field force, a drum cleaning blade 27Y for removing transfer residual toner on the photosensitive drum 23Y, a toner storage container 41Y, and a sub-hopper 42Y.

The toner storage container 41Y stores yellow toner. The toner storage container 41Y is stored in a container storage 41 provided in a body frame, is driven by a toner storage container motor provided in the body frame as a drive source, and discharges the toner to the outside. The toner discharged from the toner storage container 41Y is supplied to the sub-hopper 42Y. The sub-hopper 42Y is provided below the container storage 41, and includes a toner reservoir that temporarily stores the toner discharged from the toner storage container 41Y between the toner storage container 41Y and the developing device 24Y. The sub-hopper 42Y supplies the toner stored in the toner reservoir to the developing device 24Y in response to the remaining amount of the toner stored in the developing device 24Y becoming equal to or less than a predetermined lower limit value.

The charging roller 22Y, the exposure device 21Y, the developing device 24Y, the primary transfer roller 25Y, and the drum cleaning blade 27Y are sequentially disposed around the photosensitive drum 23Y along a rotation direction of the photosensitive drum 23Y.

The photosensitive drum 23Y is charged by the charging roller 22Y, and then irradiated with laser light emitted by the exposure device 21Y. The exposure device 21Y exposes an image corresponding portion on the surface of the photosensitive drum 23Y. As a result, an electrostatic latent image is formed on the photosensitive drum 23Y. Subsequently, the developing device 24Y develops the electrostatic latent image formed on the photosensitive drum 23Y with charged toner. Specifically, the toner is placed on the electrostatic latent image formed on the photosensitive drum 23Y by the action of an electric field force, and thus, the toner image is formed on the photosensitive drum 23Y. The toner image formed on the photosensitive drum 23Y is transferred onto the intermediate transfer belt 30 as an image carrier by the action of the electric field force by the primary transfer roller 25Y. The toner remaining without being transferred on the photosensitive drum 23Y is removed from the photosensitive drum 27Y by the drum cleaning blade 23Y.

Meanwhile, the intermediate transfer belt 30 is suspended by a driving roller 33 and a driven roller 34 so as not to be loosened. When the driving roller 33 rotates counterclockwise in FIG. 2, the intermediate transfer belt 30 rotates counterclockwise in FIG. 2 at a predetermined speed. As the intermediate transfer belt 30 rotates, the driven roller 34 rotates counterclockwise.

As a result, the image forming units 20Y, 20M, 20C, and 20K sequentially transfer the toner images onto the intermediate transfer belt 30. A timing at which each of the image forming units 20Y, 20M, 20C, and 20K transfers the toner image onto the intermediate transfer belt 30 is adjusted based on a detection of a reference mark attached to the intermediate transfer belt 30. As a result, yellow, magenta, cyan, and black toner images are superimposed on the intermediate transfer belt 30.

The toner image formed on the intermediate transfer belt 30 is transferred to the sheet by action of an electric field force by a secondary transfer roller 26 which is a transfer member. The sheet conveyed by the timing roller 31 is conveyed to a nip portion where the intermediate transfer belt 30 and the secondary transfer roller 26 are in contact with each other. The sheet to which the toner image has been transferred is conveyed to a fixing roller 32, and is heated and pressurized by the fixing roller 32. As a result, the toner is melted and fixed to the sheet. Thereafter, the sheet is discharged to a sheet discharge tray 39.

A belt cleaning blade 28 is provided upstream of the image forming unit 20Y of the intermediate transfer belt 30. The belt cleaning blade 28 removes toner remaining on the intermediate transfer belt 30 without being transferred to the sheet.

Sheets of different sizes are set in sheet feeding cassettes 35 and 35A. The sheets contained in the sheet feeding cassettes 35 and 35A are supplied to a conveyance path by take-out rollers 36 and 36A attached to the sheet feeding cassettes 35 and 35A, respectively, and are sent to the timing roller 31 by a sheet feeding roller 37.

The MFP 100 drives all of the image forming units 20Y, 20M, 20C, and 20K in the case of forming a full-color image, but drives any one of the image forming units 20Y, 20M, 20C, and 20K in the case of forming a monochrome image. Further, it is also possible to form an image by combining two or more of the image forming units 20Y, 20M, 20C, and 20K. Note that, here, an example will be described in which the MFP 100 employs a tandem system including the image forming units 20Y, 20M, 20C, and 20K that form toners of four colors on the sheet, respectively. However, a four-cycle system in which toners of four colors are sequentially transferred to a sheet on one photosensitive drum may be employed.

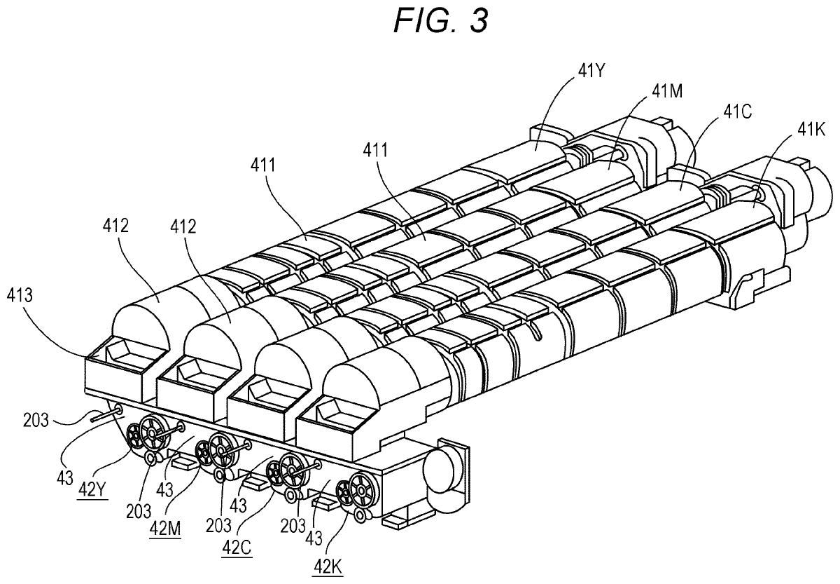

FIG. 3 is a perspective view illustrating an appearance of the toner storage container and the sub-hopper. Referring to FIG. 3, each of the toner storage containers 41Y, 41M, 41C, and 41K includes a bottle 411 that stores toner and a cap portion 412 attached to one end of the bottle 411. Sub-hoppers 42Y, 42M, 42C, and 42K are integrally provided corresponding to the toner storage containers 41Y, 41M, 41C, and 41K, respectively. In a state where the toner storage containers 41Y, 41M, 41C, and 41K are stored in the container storage 41 of the MFP 100, the toner storage containers 41Y, 41M, 41C, and 41K and the sub-hoppers 42Y, 42M, 42C, and 42K are relatively positioned.

Each of the sub-hoppers 42Y, 42M, 42C, and 42K has a hollow structure and includes a toner reservoir 43 for storing toner therein. A through hole is formed in a wall of a front surface of the toner reservoir 43, and a coupling member 203 is provided so as to pass through the through hole. The coupling member 203 is a rod-like member. The coupling member 203 passes through a through hole formed in a wall of a front surface of the toner reservoir 43 and is slidably supported by the through hole.

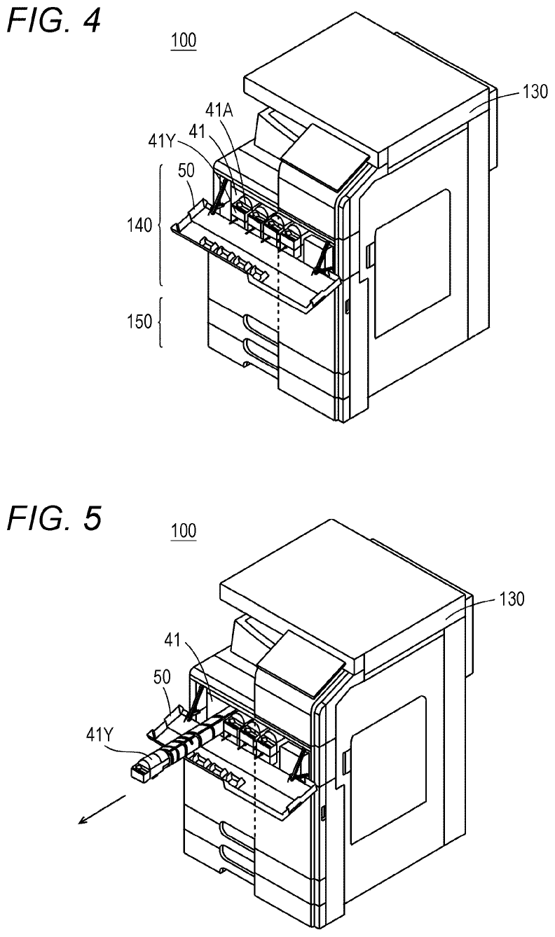

FIG. 4 is a second perspective view illustrating the appearance of the MFP according to one embodiment of the present invention. Referring to FIG. 4, FIG. 4 illustrates the MFP 100 in an open state in which the cover member 50 is opened. In the open state, the cover member 50 exposes a storage port 41A of the container storage 41 of the image former 140 to the outside. The back surface of the cover member 50 in the open state and the surface facing the inside of the MFP 100 in the closed state of the cover member 50 face upward. The storage port 41A is an opening on a front surface side of the container storage 41, and is a portion that first receives the toner storage containers 41Y, 41M, 41C, and 41K when the toner storage containers 41Y, 41M, 41C, and 41K are inserted into the container storage 41. In FIG. 4, since a state in which the toner storage containers 41Y, 41M, 41C, and 41K are stored in the container storage 41 is illustrated, the storage port 41A is hidden by the toner storage containers 41Y, 41M, 41C, and 41K and cannot be seen.

In the open state of the cover member 50, portions other than a part of the toner storage containers 41Y, 41M, 41C, and 41K and the sub-hoppers 42Y, 42M, 20C, and 20K of the image forming units 42Y, 42M, 20C, and 20K are not exposed to the outside. Therefore, in the open state of the cover member 50, the image former 140 is set to be capable of executing the image forming operation. Therefore, even when the cover member 50 is changed from the closed state to the open state during the image forming operation of the image former 140, the image former 140 continues the image forming operation without interrupting the image forming operation. In addition, since the container storage 41 is exposed when the cover member 50 is in the open state, the user can replace at least one of the toner storage containers 41Y, 41M, 41C, and 41K.

FIG. 5 is a diagram illustrating a state in which the toner storage container is replaced in the MFP; Referring to FIG. 5, the toner storage container 41Y is detached from the MFP 100 by being drawn out in the front direction from the container storage 41 of the MFP 100. Thereafter, the new toner storage container 41Y is pushed into the container storage 41 of the MFP 100 in the back direction to be mounted on to the MFP 100. In the toner storage container 41Y, the cover member 50 is attached and detached in an open state, and the toner storage container 41Y passes above the cover member 50 at the time of attachment and detachment.

The toner storage container 41Y is inserted into the container storage 41 of the MFP 100 in the longitudinal direction. Hereinafter, the longitudinal direction in which the toner storage container 41Y is inserted into the container storage 41 of the MFP 100 is referred to as an attachment/detachment direction. The attachment/detachment direction includes the front direction and the back direction.

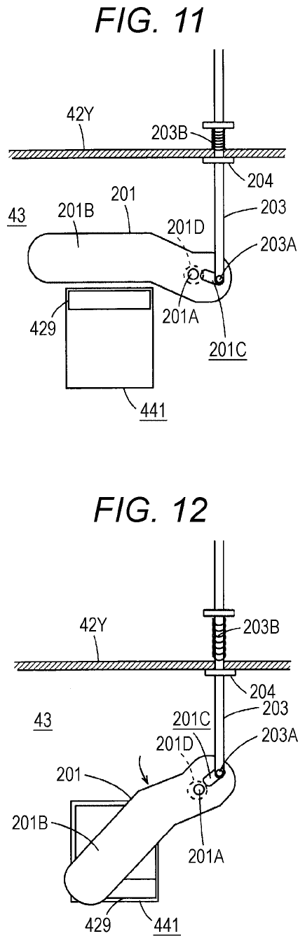

In the open state of the cover member 50, a part of each of the sub-hoppers 42Y, 42M, 42C, and 42K is exposed. The coupling member 203 protrudes in the front direction from each of the sub-hoppers 42Y, 42M, 42C, and 42K. The coupling member 203 is slidably supported in the attachment/detachment direction by each of the sub-hoppers 42Y, 42M, 42C, and 42K. The coupling member 203 is biased in the front direction by an elastic member 203B (see FIG. 11) to be described later, and moves in the front direction when the cover member 50 is in the open state. In the coupling member 203, an end of the coupling member 203 in the front direction abuts on the cover member 50 between the open state and the closed state of the cover member 50. When the cover member 50 is further closed from the position where the end of the coupling member 203 in the front direction abuts on the cover member 50, the coupling member 203 overcomes the elastic force of the elastic member 203B and is pushed in the back direction. Then, when the cover member 50 is in the closed state, the coupling member 203 is at the position moved in the back direction the most.

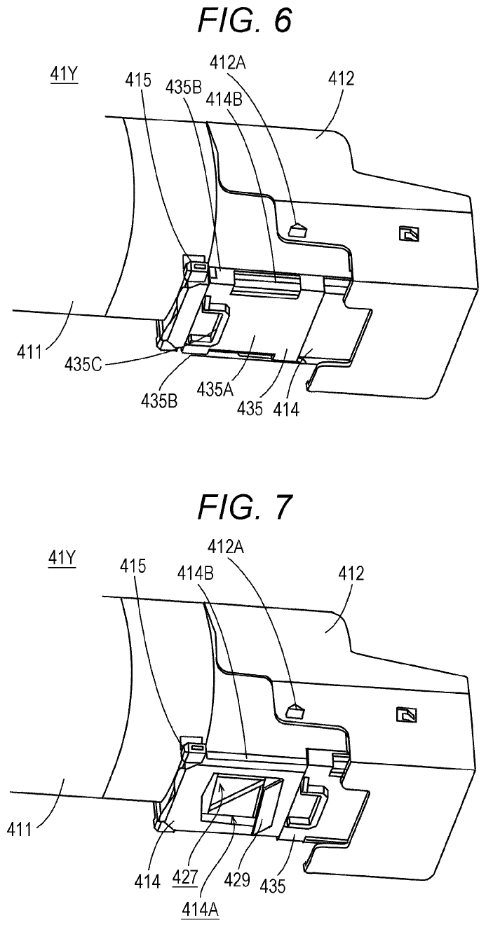

FIG. 6 is a first perspective view illustrating a part of an example of the toner storage container. FIG. 7 is a second perspective view illustrating a part of an example of the toner storage container. FIGS. 6 and 7 are views of the toner storage container 41Y as viewed from obliquely below on the front surface side. Referring to FIGS. 6 and 7, the toner storage container 41Y includes a bottle 411 that stores toner, a discharge port 427 that opens the bottle 411 to the outside, a first shutter member 429 that opens and closes the discharge port 427, a second shutter member 435, a support member 414 to which the second shutter member is attached, and a cap portion 412. The cap portion 412 has protrusions 412A protruding in the horizontal direction on both side surfaces.

FIG. 6 illustrates a state in which the second shutter member 435 is located at the detachment position, and FIG. 7 illustrates a state in which the second shutter member 435 is located at the storage position. The second shutter member 435 is attached to the bottle 411 so as to be relatively movable with respect to the bottle 411 in the attachment/detachment direction. The second shutter member 435 includes a lid member 435A having a rectangular flat plate shape, a pair of gripping portions 435B extending upward from two ends of the lid member 435A facing each other, and a shutter locking portion 435C extending downward from a lower surface of the lid member 435A. Grooves extending in an attachment/detachment direction are formed on surfaces of the pair of gripping portions 435B facing each other.

The bottle 411 includes a support member 414 disposed below the discharge port 427 and a locking portion 415 disposed adjacent to the support member 414 on the back direction side. In the support member 414, the discharge port 427 is positioned vertically downward, and a hole 414A having a size equal to or larger than a region obtained by projecting the discharge port 427 on a horizontal plane vertically downward is formed.

Grooves formed in the pair of gripping portions 435B of the second shutter member 435 are respectively engaged with the pair of ends 414B having end surfaces parallel to the attachment/detachment direction of the support member 414. As a result, the second shutter member 435 is slidable in the attachment/detachment direction with respect to the support member 414.

As illustrated in FIG. 6, in a state where the second shutter member 435 is located at the detachment position, the second shutter member 435 closes the hole 414A formed in the support member 414. Therefore, the toner contained in the bottle 411 does not leak out of the toner storage container 41Y.

As illustrated in FIG. 7, in a state where the second shutter member 435 is located at the storage position, the first shutter member 429 opens the discharge port 427, and the hole 414A formed in the support member 414 is exposed. Since the hole 414A formed in the support member 414 has a size larger than or equal to a region obtained by projecting the discharge port 427 on the horizontal plane on the lower side in the vertical direction, the toner falling from the discharge port 427 of the bottle 411 passes through the hole 414A and falls downward. Therefore, the toner contained in the bottle 411 falls from the discharge port 427 by gravity.

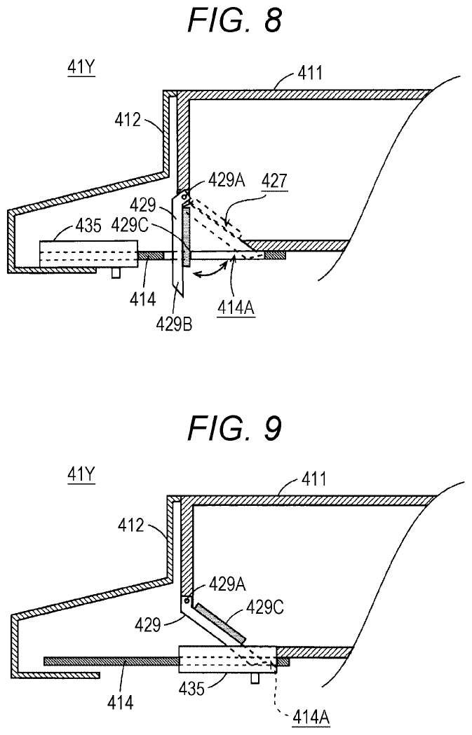

FIG. 8 is a cross-sectional view of a part of the toner storage container in a state where the second shutter member is located at the storage position. FIG. 9 is a cross-sectional view of a part of the toner storage container in a state where the second shutter member is located at the detachment position.

The first shutter member 429 has a flat plate shape and has a rotation shaft 429A at one end, and the rotation shaft 429A is pivotally supported by the bottle 411 at an end of the discharge port 427 in the front direction. The first shutter member 429 is rotatable between the closed position and the open position about the rotation shaft 429A. The closed position is a position where the discharge port 427 is closed and the bottle 411 is closed. The open position is a position where the discharge port 427 is opened and the bottle 411 is opened to the outside. In the first shutter member 429, a sheet 429C having elasticity is attached to a surface facing the bottle 411. The sheet 429C is an elastic body, and may be, for example, rubber or sponge-like urethane. Therefore, the toner can be prevented from leaking out from the discharge port 427 as much as possible in a state where the first shutter member 429 is located at the closed position.

In the rotation shaft 429A of the first shutter member 429, the rotation shaft 429A is always positioned above the center of gravity of the first shutter member 429 while the first shutter member 429 rotates between the closed position and the open position. In addition, in a contact end 429B which is an end of the first shutter member 429 on the opposite side to the rotation shaft 429A, a position of a closed position thereof is above a position at an open position thereof. Therefore, the first shutter member 429 moves from the closed position to the open position by being rotated by its own weight. In the open position, the surface of the first shutter member 429 on the side on which the discharge port 427 is closed is vertical. In addition, the first shutter member 429 rotates toward the closed position by receiving a force in the back direction from the outside in a state of being located at the open position.

In a state where the second shutter member 435 is at the storage position, the first shutter member 429 is at the open position, and the upper surface of the lid member 435A of the second shutter member 435 is located above the contact end 429B of the first shutter member 429. Ina case where the second shutter member 435 moves in the back direction in the attachment/detachment direction with respect to the bottle 411 from the state where the second shutter member is at the storage position, the second shutter member 435 abuts on the first shutter member 429, and the first shutter member 429 rotates with the contact end 429B lifted upward. Thereafter, when the contact end 429B of the first shutter member 429 ascends to the position of the upper surface of the lid member 435A of the second shutter member 435, the first shutter member 429 comes to the closed position. The second shutter member 435 further moves in the back direction in the attachment/detachment direction with respect to the bottle 411, abuts on the locking portion 415 of the bottle 411, and stops at an attachment/detachment position. During this time, the contact end 429B of the first shutter member 429 abuts on the upper surface of the lid member 435A of the second shutter member 435, and the closed state of the first shutter member 429 is maintained.

When the second shutter member 435 moves from the attachment/detachment position in the front direction in the attachment/detachment direction with respect to the bottle 411, the contact end 429B of the first shutter member 429 is not in contact with the upper surface of the lid member 435A of the second shutter member 435. When the contact end 429B of the first shutter member 429 is not in contact with the upper surface of the lid member 435A of the second shutter member 435, the contact end 429B of the first shutter member 429 starts to move downward, and the first shutter member 429 starts to rotate by its own weight about the rotation shaft 429A. The first shutter member 429 stops at the storage position where the surface of the first shutter member 429 facing the discharge port 427 is vertical. Note that the second shutter member 435 may be separated from the first shutter member 429 at the storage position.

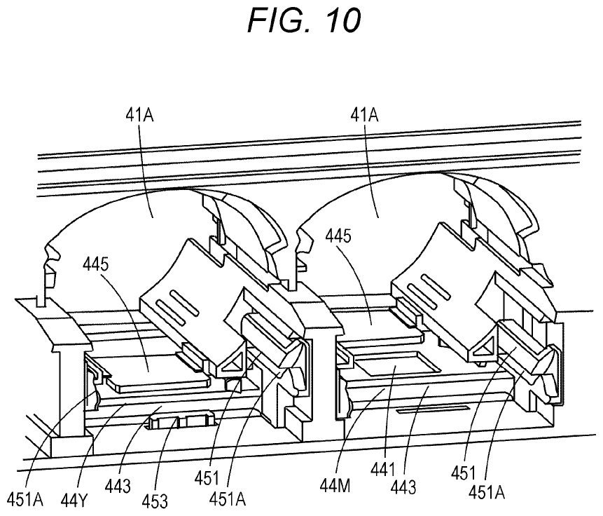

FIG. 10 is an enlarged perspective view illustrating a part of the container storage together with peripheral members. FIG. 10 illustrates a portion corresponding to the storage port 41A in which each of the toner storage containers 41Y and 41M of the container storage 41 is stored. Referring to FIG. 10, the regulator 443 is disposed below the storage port 41A of the container storage 41, and the regulating claw 453 is disposed on the front direction side of the regulator 443 at a predetermined distance. The regulator 443 is a part of the front wall on the front direction side of each of the sub-hoppers 42Y, 42M, 42C, and 42K. The regulating claw 453 is provided to be movable in the vertical direction. The regulating claw 453 is formed integrally with the pair of side guide plates 451. The pair of side guide plates 451 has sliding grooves 451A formed on surfaces facing each other. Protrusions 412A (see FIG. 6) formed on both side surfaces of the cap portion 412 of the toner storage container 41Y enter the sliding groove 451A while the toner storage container 41Y is being inserted into the container storage 41. Since the toner storage container 41Y moves in the attachment/detachment direction, the protrusion 412A also moves in the attachment/detachment direction along with the movement of the toner storage container 41Y. Therefore, the sliding groove 451A formed in the side guide plate 451 receives a force from the protrusion 412A, and the regulating claw 453 moves in the vertical direction.

The sliding groove 451A is formed in the side guide plate 451 such that the sliding groove is positioned on the lower side until the second shutter member 435 abuts on the regulator 443 after the toner storage container 41Y enters the container storage 41, and the regulating claw 453 is positioned on the upper side after the second shutter member 435 abuts on the regulator 443.

FIG. 10 illustrates a state in which the regulating claw 453 corresponding to the storage port 41A of the container storage 41 in which the toner storage container 41Y is stored is located above, and illustrates a state in which the regulating claw 453 corresponding to the storage port 41A of the container storage 41 in which the toner storage container 41M is stored is located below.

As illustrated in FIG. 10, a supply port 441 for opening the toner reservoir 43 to the outside is formed on the upper surface of the sub-hopper 42Y. In addition, in the sub-hopper 42Y, a state in which the supply port 441 is closed by a closing plate 445 is illustrated. The closing plate 445 is biased in the front direction by an elastic body such as a spring, and the locking portion 415 provided in the toner storage container 41Y abuts on the closing plate while the toner storage container 41Y is inserted into the container storage 41, and the closing plate is moved by being pushed in the back direction by the locking portion 415 to open the supply port 441.

Note that FIG. 10 illustrates a state in which the supply port 441 is opened and the regulating claw 453 is moved downward in the storage port 41A of the container storage 41 in which the toner storage container 41M is stored, but actually, it is not necessary to realize two states at the same time. When the toner storage container 41Y is stored in the container storage 41, the regulating claw 453 may move downward only while at least the shutter locking portion 435C provided in the second shutter member 435 moves from the front direction side to the back direction with respect to the regulating claw 453, and when the toner storage container 41Y is detached from the container storage 41, the regulating claw may move upward only while at least the second shutter member 435 moves from the storage position to the attachment/detachment position. In addition, the supply port 441 may be opened at least while the discharge port 427 of the toner storage container 41Y is positioned above the supply port 441.

FIG. 11 is a view of a part of the upper surface viewed from the inside of the toner reservoir of the sub-hopper when the cover member 50 is in the closed state. In FIG. 11, the upper side indicates the front direction, and the lower side indicates the back direction. Referring to FIG. 11, in the toner reservoir 43 of the sub-hopper 42Y, the supply port 441 opened to the outside is formed on the upper surface, and the toner reservoir 43 includes a closing member 201, a coupling member 203, and a rotation shaft 201A. The rotation shaft 201A protrudes inward from a predetermined position around the supply port 441 on the upper surface of the toner reservoir 43 of the sub-hopper 42Y.

The closing member 201 has a flat plate shape and includes a bearing portion rotatably coupled to the rotation shaft 201A, a closer 201B, and a connector 201C. The connector 201C is formed as a hole penetrating a position opposite to the closer 201B with respect to the rotation shaft 201A. The connector 201C has a predetermined length in a linear direction passing through the rotation shaft 201A. The closing member 201 is rotatable about the rotation shaft 201A between the closer 201B and the connector 201C. The closing member 201 is biased clockwise in the drawing by a coil spring 201D (second elastic member) attached to the rotation shaft 201A. Although the coil spring 201D is used in the present embodiment, it is not limited to the coil spring as long as it is an elastic body that biases the closing member 201 in the clockwise rotation direction in the drawing.

The coupling member 203 is slidably supported in the attachment/detachment direction by a through hole formed in the front surface of the toner reservoir 43 of the sub-hopper 42Y. A seal member 204 covering the inner periphery of the through hole is attached. Therefore, the toner stored in the toner reservoir 43 is prevented from leaking to the outside from the through hole of the toner reservoir 43 by the sliding of the coupling member 203. The coupling member 203 includes a connection member 203A extending downward in the vertical direction from an end in the back direction. The coupling member 203 and the closing member 201 are positioned such that the connection member 203A enters the connector 201C of the closing member 201, and the coupling member 203 and the closing member 201 are connected. The connection member 203A is slidable in the connector 201C.

When the cover member 50 is in the closed state, the end of the coupling member 203 on the front direction side is pushed toward the back direction side by the cover member 50, and thus, the coupling member is located on the most back direction side. Therefore, as illustrated in FIG. 11, the closing member 201 is at the second position rotated most clockwise in the closed state of the cover member 50. In the closed state of the cover member 50, the closer 201B is positioned on the front direction side of the supply port 441 and does not overlap the supply port 441 in the vertical direction. Therefore, entry of the first shutter member 429 into the supply port 441 is not hindered by the closer 201B.

FIG. 12 is a view of a part of the upper surface viewed from the inside of the toner reservoir of the sub-hopper when the cover member 50 is in the open state. Referring to FIG. 12, the coupling member 203 is biased in the front direction by the elastic member 203B (first elastic member). Here, the elastic member 203B is a spring. The elastic force of the elastic member 203B and the elastic force of the coil spring 201D are determined such that the rotational moment acting on the closing member 201 by the elastic member 203B is larger than the rotational moment acting on the closing member 201 by the coil spring 201D. Therefore, the coupling member 203 is located on the most front direction side when the cover member 50 is in the open state. When the cover member 50 is in the open state, the closing member 201 is at the first position where it has rotated most counterclockwise. The closer 201B of the closing member 201 vertically overlaps a part of the supply port 441, and the closer 201B closes a part of the supply port 441. The region where the closer 201B overlaps the supply port 441 in the vertical direction includes a portion continuous to the entire attachment/detachment direction of the supply port 441. Therefore, while the closing member 201 rotates about the rotation shaft 201A, contact of the closing member with the first shutter member 429 can be continued. Therefore, the length of the closer 201B in the radial direction passing through the bearing portion of the rotation shaft 201A is determined to be a length that can include a portion where the region where the closer 201B overlaps the supply port 441 in the vertical direction is continuous with the entire attachment/detachment direction of the supply port 441. The length of the closer 201B of the closing member 201 in the attachment/detachment direction at the second position may be larger than the thickness of the first shutter member 429.

When a failure occurs in which the coupling member 203 is not biased by the elastic member 203B due to damage or the like of the coupling member 203, the closing member 201 is biased by the coil spring 201D without receiving a rotational force from the coupling member 203. Therefore, as illustrated in FIG. 11, the closing member 201 is located at the second position that is the most rotated clockwise. Therefore, entry of the first shutter member 429 into the supply port 441 is not hindered by the closer 201B. As described above, the coil spring 201D can prevent the closing member 201 from closing the supply port 441 when the coupling member 203 is damaged or the like.

The closer 201B may not have a flat plate shape, and may have a rod shape. The closer 201B does not need to have a linear shape, and may have a curved shape or a bent or curved shape. In addition, the cross section of the closer 201B is not necessarily rectangular, and may have any cross-sectional shape. For example, the cross-sectional shape may be circular or elliptical.

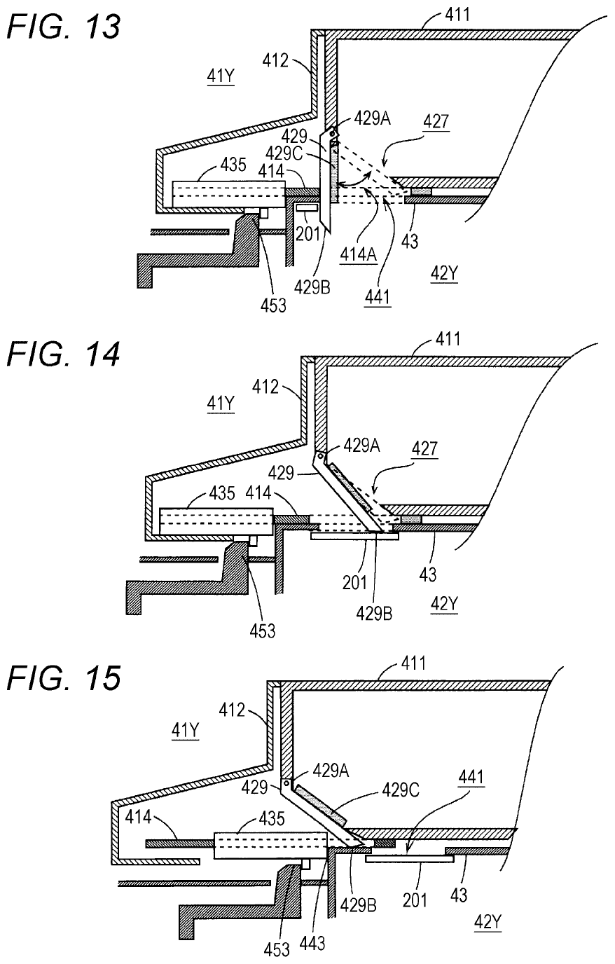

FIGS. 13 to 15 are cross-sectional views illustrating an example of a positional relationship between the sub-hopper and the toner storage container. FIG. 13 illustrates a state in which the cover member 50 is closed and the toner storage container 41Y is stored in the container storage 41. FIG. 14 illustrates a state in which the cover member 50 is in the open state and the toner storage container 41Y is stored in the container storage 41. FIG. 15 illustrates a state in which the cover member 50 is in the open state and the toner storage container 41Y is pulled out by a predetermined amount in the front direction from a state in which the toner storage container 41Y is stored in the container storage 41.

Referring to FIG. 13, the toner storage container 41Y is in a state of being completely stored in the container storage 41. The supply port 441 formed in the toner 43 of the sub-hopper 42Y is positioned vertically below the discharge port 427 formed in the bottle 411 of the toner storage container 41Y, and has a size equal to or larger than a region obtained by projecting the discharge port 427 on a horizontal plane vertically below. In addition, since the cover member 50 is in the closed state, the closing member 201 is positioned on the front direction side of the supply port 441 and does not overlap the supply port 441 in the vertical direction. Therefore, the toner reservoir 43 communicates with the bottle 411 in the vertical direction via the discharge port 427, the hole 414A, and the supply port 441.

Since the first shutter member 429 is separated from the second shutter member 435, the first shutter member rotates about the rotation shaft 429A by its own weight, and is located at the open position. In this case, a part of the second shutter member 435 enters the supply port 441, and the part exists inside the sub-hopper 42Y. Further, since the rotation shaft 429A is provided at the end in the front direction of the discharge port 427, when a part of the first shutter member 429 enters the supply port 441, the contact end 429B of the first shutter member 429 enters the supply port 441 while moving in the front direction.

In a state where the first shutter member 429 is located at the open position, the toner stored in the toner storage container 41Y is discharged from the discharge port 427, and the toner discharged from the discharge port 427 passes through the hole 414A and the supply port 441 and falls into the toner reservoir 43 of the sub-hopper 42Y. Further, when the toner in the bottle 411 is conveyed in the front direction by rotation of the bottle 411 of the toner storage container 41Y or the like, the toner that has reached the discharge port 427 is discharged from the discharge port 427.

In the closed state where the cover member 50 is closed and the toner storage container 41Y is stored in the container storage 41, the upper surface of the closing member 201 is positioned above the contact end 429B of the first shutter member 429.

When the cover member 50 is opened from the state illustrated in FIG. 13, the closing member 201 rotates, and the closer 201B moves in the back direction (the right direction in FIG. 13) in the attachment/detachment direction and is located below the supply port 441. Along with the movement of the closer 201B, the first shutter member 429 rotates about the rotation shaft 429A in a direction toward the discharge port 427. In a case where the top of the mountain formed by the accumulation of the toner accumulated in the sub-hopper 42Y reaches the vicinity of the upper surface of the toner reservoir 43, the first shutter member 429 rotates, and thus, the mountain of the toner is collapsed and the height of the mountain of the toner is lowered. Therefore, the amount of toner adhering to the surface of the first shutter member 429 opposite to the surface facing the discharge port 427 can be reduced. In addition, while the closing member 201 moves, the toner adhering to the first shutter member 429 is removed, the toner mountain is further broken by the closer 201B, and thus, the vicinity of the top of the toner mountain is leveled and uniform.

FIG. 14 illustrates a state in which the cover member 50 is in the open state and the rotation of the closing member 201 is finished. The closing member 201 is positioned vertically below the supply port 441. In this case, the closing member 201 overlaps the entire portion in the attachment/detachment direction of the supply port 441 in the vertical direction. Therefore, while the closing member 201 rotates, the first shutter member 429 can be prevented from being positioned below the upper surface of the closer 201B.

The contact end 429B of the first shutter member 429 is located on the upper surface of the closer 201B, and the discharge port 427 is not completely closed, but the opening area is reduced. In this case, the size of the gap formed by the opening of the discharge port 427 is adjusted such that the toner is not discharged or is discharged in a small amount. In this manner, it is possible to reduce the amount of toner contained in the bottle 411 discharged from the discharge port 427 in a state where the cover member 50 is in the open state and the rotation of the closing member 201 is finished. In a case where the toner contained in the bottle 411 is discharged from the discharge port 427, the toner is accumulated on the upper surface of the closer 201B or falls into the toner reservoir of the sub-hopper 42Y through the hole 414A and the supply port 441. Note that the discharge port 427 may be completely closed by increasing the thickness of the sheet 429C, changing the shape of the first shutter member 429, or the like.

When the cap portion 412 of the toner storage container 41Y is pulled out in the front direction from the state illustrated in FIG. 14 by a user, the cap portion 412 and the bottle 411 move in the front direction. Since the second shutter member 435 abuts on the regulating claw 453, the movement of the second shutter member 435 in the front direction is regulated, and the second shutter member 435 moves in the back direction relative to the bottle 411. Since the second shutter member 435 is slidable along the support member 414, the distance between the second shutter member 435 and the hole 414A formed in the support member 414 is reduced.

In addition, since the rotation shaft 429A of the first shutter member 429 is pivotally supported by the bottle 411, the rotation shaft 429A moves in the front direction. Accordingly, the contact end 429B of the first shutter member 429 moves in the front direction along the upper surface of the closer 201B. Therefore, since the size of the gap of the discharge port 427 is maintained, a state in which the amount of toner discharged from the discharge port 427 is reduced is maintained.

Further, when the cap portion 412 of the toner storage container 41Y is pulled out by the user in the front direction, the first shutter member 429 abuts on the sub-hopper 42Y at the end of the supply port 441 formed in the sub-hopper 42Y. Further, when the cap portion 412 of the toner storage container 41Y is pulled out by the user in the front direction, the contact end 429B of the first shutter member 429 rides on the upper surface of the sub-hopper 42Y while the first shutter member 429 rotates counterclockwise about the rotation shaft 429A.

FIG. 15 illustrates a state in which the contact end 429B of the first shutter member 429 rides on the contact surface of the upper surface of the sub-hopper 42Y. The contact surface is a part of the upper surface of the sub-hopper 42Y, and is a plane between the supply port 441 and the regulator 443. The contact surface is positioned at the same height as the upper surface of the lid member 435A of the second shutter member 435.

When the cap portion 412 of the toner storage container 41Y is further pulled out by the user in the front direction from the state illustrated in FIG. 15, the contact end 429B moves to the upper surface of the lid member 435A of the second shutter member 435 while maintaining the closed position of the first shutter member 429. Since the contact surface of the upper surface of the sub-hopper 42Y is positioned at the same height as the upper surface of the lid member 435A of the second shutter member 435, the contact end 429B of the first shutter member 429 can smoothly move from the upper surface of the sub-hopper 42Y to the upper surface of the lid member 435A of the second shutter member 435.

Further, when the cap portion 412 of the toner storage container 41Y is pulled out by the user in the front direction, the regulating claw 453 moves downward at the timing when the second shutter member 435 reaches the detachment position where it abuts on the locking portion 415 provided on the support member 414. Then, the entire toner storage container 41Y is removed from the container storage 41.

In addition, even when the toner storage container 41Y is stored in the container storage 41, the upper surface of the lid member 435A of the second shutter member 435 is positioned at the same height as the contact surface of the upper surface of the sub-hopper 42Y. Therefore, the contact end 429B of the first shutter member 429 can smoothly move from the upper surface of the lid member 435A of the second shutter member 435 to the upper surface of the sub-hopper 42Y. In the present embodiment, in order for the contact end 429B of the first shutter member 429 to assist the movement of the second shutter member 435 from the upper surface of the lid member 435A to the contact surface of the upper surface of the sub-hopper 42Y, the contact end 429B of the first shutter member 429 has an inclined surface inclined with respect to the upper surface of the sub-hopper 42Y in the closed state of the first shutter member 429.

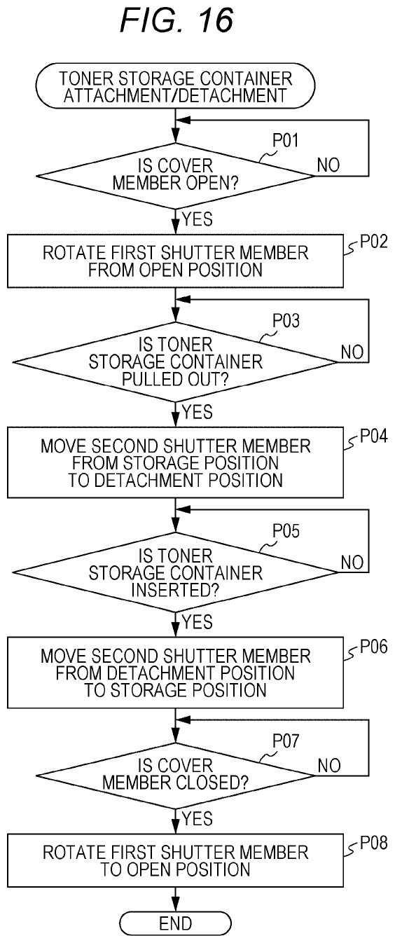

FIG. 16 is a flowchart illustrating an example of a flow of a toner storage container attachment/detachment method. Referring to FIG. 16, the toner storage container attachment/detachment method includes Step (P01) of opening the cover member 50. When the user pulls out the upper end of the cover member 50 in the front direction, the cover member 50 is changed from the closed state to the open state. At this stage, the container storage 41 is exposed to the outside, and a part of the cap portion 412 of each of the toner storage containers 41Y, 41M, 41C, and 41K stored in the container storage 41 is exposed to the outside. In parallel with the progress of Step P01, the first shutter member 429 rotates from the open position toward the closed position (Step P02). When the cover member 50 is in the open state, the end of the coupling member 203 on the front direction side is separated from the cover member 50, and thus, is biased in the front direction by the elastic member 203B. As a result, the closing member 201 rotates to the first position overlapping the supply port 441 in the vertical direction. The upper surface of the closing member 201 is positioned above the contact end 429B of the first shutter member 429. Therefore, the first shutter member 439 rotates from the open position toward the closed position.

Next, when the toner storage container 41Y is pulled out by the user (YES in P03), the second shutter member 435 moves from the storage position to the detachment position, and the discharge port 427 moves from a position where the supply port 441 overlaps the lower side of the discharge port 427 in the vertical direction to a position where the supply port 441 does not overlap the lower side of the discharge port 427 in the vertical direction (Step P04). When the toner storage container 41Y moves in the front direction, since the second shutter member 435 abuts on the regulating claw 453, the movement of the second shutter member 435 in the front direction is regulated. Therefore, the second shutter member 435 moves to the detachment position in the back direction relative to the bottle 411. While the second shutter member 435 moves from the storage position to the detachment position, the contact end 429B of the first shutter member 429 moves to the upper surface of the lid member 435A of the second shutter member 435 while maintaining the closed position. After the second shutter member 435 moves to the detachment position, the regulating claw 453 moves downward, and thus, the second shutter member 435 moves in the front direction together with the bottle 411.

Next, when a new toner storage container 41Y is inserted by the user (YES in P05), the second shutter member 435 moves from the detachment position to the storage position, and the discharge port 427 moves from the position where the supply port 441 does not overlap below the discharge port 427 in the vertical direction to the position where the supply port 441 overlaps below the discharge port 427 in the vertical direction (Step P06). When the new toner storage container 41Y is inserted in the back direction by the user, the second shutter member 435 abuts on the regulator 443 and the movement of the second shutter member in the back direction is regulated. Therefore, the second shutter member 435 moves from the detachment position to the storage position in the front direction with respect to the bottle 411. When the toner storage container 41Y is further inserted by the user and stored in the container storage 41, the contact end 429B of the first shutter member 429 abuts on the upper surface of the closing member 291.

Next, the cover member 50 is closed (Step P07). When the user closes the cover member 50 from the open state, the cover member 50 is closed. Accordingly, the container storage 41 is not exposed to the outside. In parallel with the progress of Step P07, the first shutter member 429 is rotated to the open position (Step P08). When the cover member 50 is closed, the end of the coupling member 203 on the front direction side overcomes the elastic force of the elastic member 203B by the cover member 50 and is pushed in the back direction. As a result, the closing member 201 rotates to the second position not overlapping the supply port 441 in the vertical direction. Therefore, first shutter member 439 rotates to the open position by its own weight. Since the discharge port 427 of the bottle 411 is opened to the outside with the first shutter member 439 at the open position and the discharge port 427 overlaps with the supply port 441 in the vertical direction, the toner accommodated in the bottle 411 is supplied to the sub-hopper 42Y.

As described above, the MFP 100 according to the present embodiment functions as an image forming apparatus, and the toner storage containers 41Y, 41M, 41C, and 41K that store toner are detachable. Each of the toner storage containers 41Y, 41M, 41C, and 41K includes the bottle 411 that stores toner, the discharge port 427 that opens the bottle 411 to the outside, the first shutter member 429 that is rotatably attached to the bottle 411 between the closed position where the discharge port 427 is closed and the open position where the discharge port 427 is opened, and the second shutter member 435 that is provided to be relatively movable with respect to the bottle 411 in the attachment/detachment direction in which the toner storage container is attached/detached between the storage position where the toner storage container is separated from the first shutter member 429 at the open position and the detachment position where the toner storage container is in contact with the first shutter member 429 at the closed position. The MFP 100 includes the container storage 41 that has the storage port 41A and stores the toner storage containers 41Y, 41M, 41C, and 41K, the toner reservoir 43 that is provided below the container storage 41 and has a supply port 441 formed vertically below the discharge port 427 of each of the toner storage containers 41Y, 41M, 41C, and 41K stored in the container storage 41, the regulator 443 that moves the second shutter member 435 from the detachment position to the storage position, the cover member 50 that opens or closes the storage port 41A, and the switcher that rotates the first shutter member 429 of each of the toner storage containers 41Y, 41M, 41C, and 41K stored in the container storage 41 in conjunction with the opening/closing operation of the cover member 50.

In the MFP 100, since the second shutter member 435 is moved from the detachment position to the storage position by the regulator 443, the second shutter member 435 is separated from the first shutter member 429. As a result, the first shutter member 429 rotates from the closed position to the open position, and the discharge port 427 is opened. When the discharge port 427 is opened, the toner accommodated in the bottle 411 is discharged from the discharge port 427, and the toner is supplied from the supply port 441 to the toner reservoir 43. The first shutter member 429 rotates in conjunction with the opening/closing operation of the cover member 50. Therefore, an opening area of the discharge port 427 can be changed by opening and closing the cover member 50. Therefore, in the stage before the second shutter member 435 moves to the detachment position, the opening area of the discharge port 427 can be reduced, and the amount of toner discharged from the discharge port 427 can be reduced. As a result, the amount of toner leaking from the toner storage container can be reduced while the toner storage containers 41Y, 41M, 41C, and 41K are attached and detached.

In addition, the rotation shaft 429A of the first shutter member 429 is provided on the side of the regulator 443 of the discharge port 427 in the state where each of the toner storage containers 41Y, 41M, 41C, and 41K is stored in the container storage 41, and a part of the first shutter member 429 located at the open position is located below the supply port 441 in the state where each of the toner storage containers 41Y, 41M, 41C, and 41K is stored in the container storage 41. The MFP 100 includes the closing member 201 that is provided so as to be movable to the first position where at least a part of the closer 201B overlaps at least a part of the supply port 441 in the vertical direction and the second position closer to the regulator 443 than the supply port 441, and the coupling mechanism that moves the closing member 201 to the second position when the cover member 50 is in the closed state of closing the storage port 41A and moves the closing member 201 to the first position when the cover member 50 is in the open state of opening the storage port 41A. Therefore, when the cover member 50 is in the closed state, the closing member 201 is positioned closer to the regulator 443 than the supply port 441, and the closing member 201 does not come into contact with the first shutter member 429, so that the first shutter member 429 is at the open position. On the other hand, when the cover member 50 is in the open state, since the closing member 201 overlaps a part of the supply port 441 in the vertical direction, the closing member 201 abuts on the first shutter member 429. In addition, since the closing member 201 moves from the regulator 443 side of the supply port 441 to the supply port 441, the first shutter member 429 positioned below the supply port 441 is rotated in a direction toward the closed position. Therefore, the open area of the discharge port 427 can be reduced.

Further, the coupling mechanism includes the coupling member 203 provided to be movable in parallel with the attachment/detachment direction, and an elastic member 203B that biases the coupling member 203 in the direction from the rear end toward the front end. The closing member 201 is connected to the rear end of the coupling member 203 at a connector 201C, and is attached to the toner reservoir 43 so as to be rotatable about a rotation shaft 201A between the connector 201C and the closer 201B. The front end of the coupling member 203 abuts on the cover member 50 in the stage between the closed state and the open state of the cover member 50, and the front end of the coupling member 203 is separated from the cover member 50 in the open state of the cover member 50. Therefore, since the closing member 201 is attached to the toner reservoir 43 so as to be rotatable about the rotation shaft 201A between the connector 201C and the closer 201B, the closer 201B moves in the direction opposite to the direction in which the rear end of the coupling member 203 moves. The front end of the coupling member 203 abuts on the cover member 50 at a stage between the closed state and the open state of the cover member 50, and the coupling member 203 moves in a direction from the front end to the rear end by a pressing force received from the cover member 50 in the closed state of the cover member 50. Therefore, the closing member 201 can be moved to the second position. Further, the coupling member 203 is separated from the cover member in the open state of the cover member 50, and moves in the direction from the rear end toward the front end by the biasing force of the elastic member 203B. Therefore, the closing member 201 can be moved to the first position. In this manner, the closing member 201 can be moved in the attachment/detachment direction in conjunction with the opening and closing of the cover member 50.

The closing member 201 is biased in a direction from the first position to the second position by the coil spring 201D. The elastic force of each of the elastic member 203B and the coil spring 201D is determined such that the rotational moment acting on the closing member 201 by the elastic member 203B is larger than the rotational moment acting on the closing member 201 by the coil spring 201D. Therefore, the closing member 201 moves to the second position by the coil spring 201D in a state where the elastic member 203B does not bias the coupling member 203 and in a state where the cover member 50 is closed. Therefore, even when the elastic member 203B cannot bias the coupling member 203, the toner discharged from the toner storage container 41Y can be supplied to the toner reservoir 43.

The closing member 201 is provided inside the toner reservoir 43. Therefore, since the closing member 201 is provided inside the toner reservoir 43, the configuration of the container storage 41 can be simplified, and the toner storage containers 41Y, 41M, 41C, and 41K can be easily attached and detached.

In addition, the through hole through which the coupling member 203 passes is formed in the toner reservoir 43, and the seal member 204 provided between the through hole and the coupling member 203 is further included. Therefore, the amount of toner falling down from the toner reservoir 43 can be reduced.

In addition, the closing member 201 includes a portion vertically overlapping a portion continuous in the attachment/detachment direction of the supply port 441 at the first position. Therefore, since the closing member 201 includes the portion where the closer 201B vertically overlaps with a portion continuous in the attachment/detachment direction of the supply port 441 at the first position, it is possible to maintain a state where the closing member 201 is in contact with the first shutter member 429 regardless of the position of each of the toner storage containers 41Y, 41M, 41C, and 41K.

In addition, the length of the closer 201B of the closing member 201 in the attachment/detachment direction at the second position is larger than the thickness of the first shutter member 429.

In addition, the contact surface having the same height as a surface on which the second shutter member 435 of each of the toner storage containers 41Y, 41M, 41C, and 41K stored in the container storage 41 comes into contact with the first shutter member 429 is further provided between the regulator 443 and the supply port 441. The rotational position of the first shutter member 429 while the first shutter member 429 is in contact with the second shutter member 435 is the same as the rotational position of the first shutter member 429 while the first shutter member 429 is in contact with the contact surface. Therefore, the first shutter member 429 can be set to the closed position while the first shutter member 429 does not enter the supply port 441.

The toner storage container attachment/detachment method for attaching/detaching the toner storage containers 41Y, 41M, 41C, and 41K to/from the MFP 100 according to the present embodiment includes opening/closing the cover member 50, rotating the first shutter member at the open position toward the closed position in response to a change from the closed state where the cover member 50 is closed to the open state where the cover member 50 is opened in the state where the toner storage containers 41Y, 41M, 41C, and 41K are stored in the container storage 41, and rotating the first shutter member to the open position in response to the change of the cover member 50 from the open state to the closed state in the state where the toner storage containers 41Y, 41M, 41C, and 41K are stored in the container storage 41. Therefore, the amount of toner leaking from the toner storage container can be reduced while the toner storage containers 41Y, 41M, 41C, and 41K are attached to and detached from the MFP 100.

Further, the toner storage container attachment/detachment method further includes moving the toner storage containers 41Y, 41M, 41C, and 41K in the container storage 41 so that the second shutter member 435 moves between the detachment position and the storage position. Therefore, the second shutter member 435 can be moved by an operation of moving the toner storage containers 41Y, 41M, 41C, and 41K.

In addition, the moving of the toner storage containers 41Y, 41M, 41C, and 41K into the container storage 41 includes moving the toner storage containers 41Y, 41M, 41C, and 41K into the container storage 41 between the position where the supply port 441 formed in the toner reservoir 43 provided below the container storage 41 overlaps below the discharge port 427 in the vertical direction and the position where the supply port 441 does not overlap below the discharge port 427 in the vertical direction. Therefore, relative positions of the toner reservoir 43 and the toner storage containers 41Y, 41M, 41C, and 41K can be aligned by moving the toner storage containers 41Y, 41M, 41C, and 41K.

It should be understood that the embodiments disclosed herein are illustrative in all respects and not restrictive. The scope of the present invention is indicated not by the above description but by the claims, and it is intended that meanings equivalent to the claims and all modifications within the scope are included.

### SUPPLEMENTARY NOTE

(1) The image forming apparatus according to any one of claims 1 to 8, wherein a surface of the second shutter member in contact with the first shutter member at the detachment position is located above at least a part of the first shutter member at the storage position.

According to this aspect, by moving the second shutter member from the storage position to the detachment position, the first shutter member can be rotated from the open position to the closed position.

(2) The image forming apparatus according to any one of claims 1 to 8, wherein the regulator is provided closer to the storage port than the supply port.

According to this aspect, since the regulator abuts on the second shutter member at the detachment position at the stage before the toner storage container is stored in the container storage and regulates the entry of the second shutter member into the container storage, the second shutter member can be moved to the storage position at the stage in which the toner storage container is stored.

(3) The image forming apparatus according to any one of claims 1 to 8, further including a regulating claw that regulates movement of the second shutter member in a direction separated from the container storage in a state where the second shutter member is at the storage position.

According to this aspect, the second shutter member can be moved from the storage position to the attachment/detachment position when the toner storage container moves in the direction separated from the container storage in the attachment/detachment direction.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming apparatus capable of detachably attaching a toner storage container, the toner storage container including:
a bottle that stores toner;
a discharge port that opens the bottle to an outside;
a first shutter member that is rotatably attached to the bottle between a closed position where the discharge port is closed and an open position where the discharge port is opened; and
a second shutter member that is provided to be relatively movable with respect to the bottle in an attachment/detachment direction in which the toner storage container is attached/detached between a storage position where the toner storage container is separated from the first shutter member at the open position and a detachment position where the toner storage container is in contact with the first shutter member at the closed position, the image forming apparatus comprising:
a container storage that has a storage port and stores the toner storage container;
a toner reservoir that is provided below the container storage and has a supply port formed vertically below the discharge port of the toner storage container stored in the container storage;
a regulator that moves the second shutter member from the detachment position to the storage position;
a cover member that opens or closes the storage port; and
a switcher that rotates the first shutter member of the toner storage container stored in the container storage in conjunction with an opening/closing operation of the cover member.

2. The image forming apparatus according to claim 1,
wherein a rotation shaft of the first shutter member is provided on a side of the regulator of the discharge port in a state where the toner storage container is stored in the container storage,
a part of the first shutter member located at the open position is located below the supply port in the state where the toner storage container is stored in the container storage, and
the switcher includes a closing member provided such that at least a part of a closer is movable to a first position overlapping at least a part of the supply port in the vertical direction and a second position closer to the regulator than the supply port and a coupling mechanism that moves the closing member to the second position when the cover member is in a closed state in which the storage port is closed, and moves the closing member to the first position when the cover member is in an open state in which the storage port is opened.

3. The image forming apparatus according to claim 2,
wherein the coupling mechanism includes a coupling member provided to be movable in parallel with the attachment/detachment direction and a first elastic member that biases the coupling member in a direction from a rear end toward a front end,
the closing member is connected to the rear end of the coupling member at a connector, and is attached to the toner reservoir so as to be rotatable about a rotation shaft between the connector and the closer, and
the front end of the coupling member abuts on the cover member in a stage between the closed state and the open state of the cover member, and the front end of the coupling member is separated from the cover member in the open state of the cover member.

4. The image forming apparatus according to claim 3, further comprising
a second elastic member that biases the closing member in a direction from the first position toward the second position,
wherein an elastic force of each of the first elastic member and the second elastic member is determined such that a rotational moment acting on the closing member by the first elastic member is larger than a rotational moment acting on the closing member by the second elastic member.

5. The image forming apparatus according to claim 3, wherein the closing member is provided inside the toner reservoir.

6. The image forming apparatus according to claim 5,
wherein a through hole through which the coupling member passes is formed in the toner reservoir, and
the image forming apparatus further includes a seal member provided between the through hole and the coupling member.

7. The image forming apparatus according to claim 2, wherein the closer includes a portion vertically overlapping a portion continuous in the attachment/detachment direction of the supply port at the first position.

8. The image forming apparatus according to claim 7, wherein a length of the closer of the closing member in the attachment/detachment direction at the second position is larger than a thickness of the first shutter member.

9. The image forming apparatus according to claim 1, further comprising a contact surface between the regulator and the supply port, the contact surface having the same height as a surface of the second shutter member of the toner storage container stored in the container storage, the surface being in contact with the first shutter member.

10. A toner storage container attachment/detachment method for attaching/detaching a toner storage container to/from an image forming apparatus, the toner storage container including:
a bottle that stores toner;
a discharge port that opens the bottle to an outside;
a first shutter member that is rotatably attached to the bottle between a closed position where the discharge port is closed and an open position where the discharge port is opened; and
a second shutter member that is provided to be relatively movable with respect to the bottle in an attachment/detachment direction in which the toner storage container is attached/detached between a storage position where the toner storage container is separated from the first shutter member at the open position and a detachment position where the toner storage container is in contact with the first shutter member at the closed position, the method comprising:
opening and closing a cover member that opens and closes a storage port of a container storage that stores the toner storage container;
rotating the first shutter member at the open position toward the closed position in response to a change from a closed state where the cover member is closed to an open state in which the cover member is opened in a state where the toner storage container is stored in the container storage; and
rotating the first shutter member to the open position in response to a change of the cover member from the open state to the closed state in the state where the toner storage container is stored in the container storage.

11. The toner storage container attachment/detachment method according to claim 10, further comprising moving the toner storage container in the container storage such that the second shutter member moves between the detachment position and the storage position.

12. The toner storage container attachment/detachment method according to claim 11, wherein the moving of the toner storage container into the container storage includes moving the toner storage container into the container storage between a position where a supply port formed in a toner reservoir provided below the container storage overlaps below the discharge port in a vertical direction and a position where the supply port does not overlap below the discharge port in the vertical direction.
